(19) United States
(12) Patent Application Publication
(10) Pub. No.: US 2025/0074575 A1
(43) Pub. Date: Mar. 6, 2025

(54) WING SUB-ASSEMBLY

(71) Applicant: Airbus Operations Limited, FILTON (GB)

(72) Inventor: James SAUVEN, FILTON (GB)

(21) Appl. No.: 18/794,043

(22) Filed: Aug. 5, 2024

(30) Foreign Application Priority Data
Aug. 29, 2023 (GB) 2313112.1

(51) Int. Cl. B64C 3/26; B64F 5/10

(52) U.S. Cl. CPC B64C 3/26; B64F 5/10

(57) ABSTRACT

A wing is manufactured from a sub-assembly made up of a structural component such as a wing rib, and a nut. The structural component has a first seating surface for supporting a lower skin of the wing and a second seating surface for supporting an upper skin of the wing. An aperture extends along an aperture axis, through one of the seating surfaces. A nut retention structure of the structural component holds the nut aligned with the aperture, but allows the nut to move laterally relative to the aperture axis so as to accommodate slight misalignment between the aperture and a hole in one of the skins.

### CROSS-REFERENCES TO RELATED APPLICATIONS

This application claims the benefit of Great Britain Patent Application Number 2313112.1 filed on Aug. 29, 2023, the entire disclosures of which are incorporated herein by way of reference.

### FIELD OF THE INVENTION

The present disclosure relates to the field of aircraft wings. It relates particularly, but not exclusively, to a wing sub-assembly for an aircraft wing, an aircraft wing, an aircraft comprising such a wing, and a method of manufacturing an aircraft wing.

### BACKGROUND OF THE INVENTION

Conventional aircraft wings often have upper and lower skins, or covers, supported by a wing frame. The skins form the outer shape of the wing, while the frame provides some or all of the structural support for the wing. The frame usually has a front spar and a rear spar each of which runs spanwise along the wing, and a set of ribs distributed along the wing between the spars. Generally speaking, the front and rear spars bear most of the lift loads and drag loads experienced by the wing, while the ribs hold the upper and skins apart from one another by the required distance so as to prevent the skins buckling and maintain the airfoil shape of the wing.

In the manufacture of such wings, the frame is generally assembled first, then the frame and the skins are placed into a jig which holds them in the correct locations and the skins are bolted to the frame. Often the skins and the frame are pre-drilled, with each hole in a skin lining up with a corresponding hole in a rib or spar of the frame when the components are placed in the jig. Bolts are then inserted through the pairs of aligned holes, through the skin and then into the frame, and nuts are threaded onto the distal ends of the bolts. The nuts are then supported from within the wing by an operator, and the bolts are tightened.

Due to the effects of tolerance stacking and/or thermal expansion, some holes in the skins can be slightly misaligned relative to the corresponding holes in the frame when the components are placed into the jig. This can necessitate time-consuming re-adjustment of the different components, and can potentially also lead to parts wastage.

One way of addressing the problem of misaligned holes is to match-drill the holes with the skins and frame already held in place in the jig. Commonly an operator drills a pilot hole from the inside of the wing, through the frame and then to the outside through one of the skins. Then, using that hole as a guide, a full-size hole is drilled from the outside to the inside. In an alternative approach, a magnetic marker is positioned at the required spot on the inside of the wing, then a specialist drill guide on the outside is aligned with the magnetic marker using the magnetic field it generates. The drill guide is then clamped in place, the marker is removed, and drilling is performed under guidance of the drill guide.

While match-drilling can reduce the prevalence of mis-aligned holes, the problem still remains to some extent, particularly when utilizing pilot holes. Cramped conditions inside the wing can make it difficult for operators to drill the pilot holes exactly perpendicularly. This can mean that the outer end of the pilot hole (on which drilling of the full size hole is centered) is incorrectly positioned. Also, the full size hole is drilled perpendicularly (since there is sufficient space to do so), rather than following the angle of the pilot hole. Accordingly, the two holes may diverge from one another, leading to the inner ends of the holes only partially lining up. This, in turn, can create a bolt hole which is oval at the inner end and potentially unsuitable for use.

Using a magnetic target is generally successful at preventing hole misalignment when used correctly, but is a particularly time-consuming process (even more so than using pilot holes) and requires expensive specialist machinery. Also, regardless of how match-drilling is performed, removal of swarf from drilling is more difficult with the skins already in position.

Another problem with existing production processes, regardless of how the bolt holes are drilled, is that access to both sides of each joint is required. The nut must be supported from one side and the bolt inserted from the other, then both sides must be supported during tightening. This need for access places significant design constraints on the shape and structure of the wing, and even when access is possible, it may require operators to climb and/or reach into small spaces inside the wing so as to support the nut at the requisite location, which is relatively time-consuming.

The present invention seeks to mitigate one or more of the above-mentioned problems. Alternatively or additionally, the present invention seeks to provide an improved or alternative sub-assembly, aircraft wing component, aircraft wing, aircraft or method of manufacturing an aircraft wing.

### SUMMARY OF THE INVENTION

According to a first aspect of the present disclosure there is provided a wing sub-assembly for an aircraft wing, the wing sub-assembly comprising a structural component and an internally-threaded nut, wherein:
the structural component comprises a first seating surface positioned to engage a lower skin of the aircraft wing, and a second seating surface positioned to engage an upper skin of the aircraft wing;
the structural component has a bolt aperture which extends along an aperture axis and passes through one of the seating surfaces; and
the structural component has a nut retention structure configured to hold the nut in alignment with the aperture but permit limited lateral movement of the nut relative to the aperture axis.

With the nut being held in alignment with the aperture by the nut retention structure, it may be unnecessary for an operator to support the nut during insertion of a bolt. This, in turn, may reduce the number of design constraints which the design of the wing must fulfil, and/or may speed assembly by removing that relatively difficult step in the assembly process.

The nut being able to move laterally relative to the aperture may allow a joint to be made using pre-drilled holes without the need for adjustment during assembly. The nut may be able to move into alignment with a hole in a skin (and thus with a bolt inserted through that hole) even if the hole in the skin is slightly misaligned with the aperture in the structural component.

Reference herein to lateral movement of the nut is not intended to be limited to movement which would be lateral in respect of an aircraft of which the sub-assembly may be part. Rather, it is intended to refer to movement which is not parallel to or collinear with the aperture axis.

The nut retention structure may be configured to permit the nut to move at least 1 mm, at least 2 mm, at least 3 mm, at least 4 mm or at least 5 mm in one or more lateral directions.

The nut may be considered to be in alignment with the aperture if a straight line passing through the aperture, parallel to or collinear with the aperture axis, intersects the nut.

A component may be considered to be a structural component if it provides significant physical support to a skin of the wing. Components such as inspection hatches, aerodynamic covers and the like are not structural components.

The structural component may be a structural member, that is to say, a unitary body. As an alternative, the structural component may comprise two or more parts joined together.

Optionally, the nut has a threaded hole and the nut retention structure is configured to hold the threaded hole of the nut in alignment with the aperture. The threaded hole may be considered to be aligned with the aperture if a straight line passing through the aperture, parallel to or collinear with the aperture axis, intersects the threaded hole.

The seating surfaces of the structural component may support their respective skins via abutment, either through direct contact therewith or via one or more intermediate components or layers.

For the avoidance of doubt, reference to the above components forming a sub-assembly is not intended to mean that the sub-assembly is necessarily assembled separately from other components, or assembled at a different time to other parts of a wing or aircraft.

The structural component may be a rib or a spar.

One or more of the advantages discussed above may be of particular benefit in respect of ribs or spars, since these often extend into relatively inaccessible parts of a wing.

Where the structural component is a rib, that rib may be generally airfoil-shaped, may be generally rectangular or may take any other suitable shape. Where the structural component is a spar, it may be a front spar, a rear spar, or an intermediate spar configured to be positioned between a front spar and a rear spar.

As an alternative, the structural component may be any other suitable component which is has seating surfaces configured to engage both upper and lower skins and provides physical support, for instance a housing of a fuel pump or a stand-alone reinforcement member.

The nut retention structure may be configured to permit lateral movement of the nut in a plane which is generally normal to the aperture axis.

The nut being movable in the plane can allow the nut to move to compensate for hole misalignment in any direction.

As an alternative, the nut retention structure may be configured to permit lateral movement of the nut in a limited number of directions, for instance movement along a single axis which is generally normal to the aperture axis.

The nut retention structure may comprise a cavity in which the nut is held.

A cavity may be a beneficially robust and/or easy to manufacture apparatus by which the nut may be held in alignment and permitted limited lateral movement.

Instead or as well, the nut retention structure may comprise one or more projections which abut and/or overlie the nut.

At least part of the cavity may be integral to the structural component.

This may reduce the assembly time of the structural component and thus of the sub-assembly as a whole.

Alternatively, however, the cavity may be provided by a separate component which is attached to a main body of the structural component.

The cavity may have an entrance configured for insertion of the nut into the cavity therethrough, and a cover which closes the entrance.

This may allow assembly of the structural component, and thus of the sub-assembly as a whole, to be advantageously easy to understand and/or quick to perform.

As one alternative, the cavity may be entirely enclosed, having been formed or assembled around the nut without an entrance being provided.

The cover may have a sealing member which seals the entrance.

Sealing the cavity in this way can eliminate a leakage path through the cavity to the outside. This, in turn, can allow the structural component to be positioned in, or at the boundary of, an in-wing fuel tank. It may be particularly beneficial for that leakage path to be sealed by the cover because this may make it possible for the seal to be pressure tested separately and in advance, rather than the pressure testing taking place after the sub-assembly has been used in the manufacture of a wing (in which case the pressure testing may be more difficult, and/or remedying any problems with the seal may be more complex and time-consuming).

As an alternative, the cover may close the entrance with one or more gaps. In such an arrangement sealing may be unnecessary (due to the structural component not being in or at the boundary of a fuel tank, for instance), or sealing may be provided elsewhere (for instance as a separate layer provided over the top of the cover and the surrounding part of the structural component, or in the leakage path downstream of the aperture).

The nut retention structure may have an anti-rotation feature which limits rotation of the nut about the aperture axis.

The anti-rotation feature may be beneficial in reducing or eliminating the possibility of the nut rotating along with a bolt rather than being tightened.

The anti-rotation feature may be a wall (for instance a wall of a chamber, where present) positioned in the path of part of the nut during rotation. As one alternative, the anti-rotation feature may be a projection received in a complementary recess in the nut, for instance a key received in a keyway in the nut (with sufficient clearance between the key and keyway to permit lateral movement of the nut).

As an alternative, no anti-rotation feature may be present, at which point friction between the nut and a portion of the structural component may be used to limit its rotation and allow a bolt to be tightened.

The nut retention structure may be configured to permit the nut less freedom of movement in a direction parallel to the aperture axis than in a direction normal to the aperture axis.

For instance, the nut retention structure may be configured to substantially prevent movement of the nut in a direction parallel to the aperture axis.

This may enable easier insertion of a bolt into the nut, due to the nut being less able (or substantially unable) to lift up along the aperture axis when contacted by a bolt being inserted.

As an alternative, the nut may have freedom of movement in a direction parallel to the aperture which is as great as or greater than the freedom of movement of the nut in a direction normal to the aperture axis.

The nut may have a threaded hole with a minor diameter and the aperture may have a minimum diameter, the minimum diameter of the aperture being larger than the minor diameter of the threaded hole of the nut.

The minimum diameter of the aperture may be at least 1 mm, at least 2 mm, at least 3 mm, at least 4 mm or at least 5 mm larger than the minor diameter of the threaded hole of the nut.

This relatively large difference between diameters may allow the sub-assembly to accommodate relatively large hole misalignments.

The minimum diameter of an aperture may be considered to be the smallest diameter around the circumference of the aperture. For example, where the aperture is elliptical in cross section its minimum diameter may be its diameter across its minor axis. Where the aperture is circular in cross section, its minimum diameter is merely its diameter.

The minor diameter of the threaded hole may be considered to be the diameter of the hole excluding the threads, i.e. the largest diameter of plain rod which could be received within the threaded hole.

The nut may have a flared mouth which faces towards the aperture.

The flared mouth may provide a self-centering action with a bolt, with the distal end of the bolt camming the nut into alignment. Instead or as well, such a self-centering action may be provided using a bolt with a tapered distal end.

In the absence of such a self-centering action, an aligning tool may be inserted into the aperture and used to move the nut into the correct position.

According to a second aspect of the present disclosure there is provided an aircraft wing component comprising a skin support and fastener with a female thread, wherein:
the skin support has a first surface for supporting a first wing skin and a second surface for supporting a second wing skin, the first and second surfaces facing in generally opposite directions;
the skin support has a hole which passes through the first surface or the second surface;
the fastener is mounted to the skin support using mounting features which retain the fastener while allowing the fastener to move sideways relative to the hole.

With the fastener being retained by the mounting features, it may be unnecessary for an operator to support the fastener during tightening of a complementary fastener with a male thread that is engaged therewith. This, in turn, may reduce the number of design constraints which the design of the wing must fulfil, and/or may speed assembly by removing that relatively difficult step in the assembly process.

The fastener being able to move sideways relative to the hole may allow a joint to be made using pre-drilled holes without the need for adjustment. The fastener may be able to move into alignment with a hole in a skin (and thus with a fastener with a male thread inserted through that hole) even if the hole in the skin is slightly misaligned with the hole in the skin support.

According to a third aspect of the present disclosure there is provided an aircraft wing comprising:
a sub-assembly according to the first aspect of the disclosure;
a lower skin engaged by the first seating surface;
an upper skin engaged by the second seating surface; and
a bolt having a shank which extends from a head end, through an opening in one of the skins and through the aperture, to a distal end which is threadedly engaged with the nut.

An aircraft wing according to the third embodiment of the disclosure may exhibit one or more of the advantages in production discussed above in respect of the first aspect of the disclosure.

The seating surfaces may engage their respective skins via direct abutment therewith.

As an alternative, the aircraft wing may further comprise an intermediate layer positioned between the seating surface through which the aperture passes, and the corresponding skin.

The intermediate layer may provide one or more advantages in terms of increasing friction, reducing vibration transmission or improving adhesion between the skin and its seating surface. For example, the intermediate layer may be a layer of high-friction material, a layer of vibration-damping material and/or a layer of adhesive.

The intermediate layer may be positioned circumferentially around the aperture.

As an alternative, the intermediate layer may be a sealing gasket.

It is to be understood that the intermediate layer may perform more than one of the above roles. For instance, a single intermediate layer may be a sealing gasket that also acts to dampen vibration and/or increase friction.

According to a fourth aspect of the present disclosure, there is provided an aircraft comprising an aircraft wing sub-assembly according to the first aspect of the disclosure, an aircraft wing component according to the second aspect of the disclosure and/or an aircraft wing according to the third aspect of the disclosure.

An aircraft according to the fourth aspect of the disclosure may exhibit one or more of the advantages in production discussed above.

According to a fifth aspect of the present disclosure there is provided a method of manufacturing an aircraft wing, the method comprising:
(a) providing a structural component which comprises a first seating surface, a second seating surface, and a bolt aperture which extends along an aperture axis and passes through one of the seating surfaces;
(b) mounting an internally-threaded nut to the structural component using a nut retention structure, the nut retention structure holding the nut in alignment with the aperture but permitting limited lateral movement of the nut relative to the aperture axis; and
(c) positioning a lower wing skin in abutment with the first seating surface and securing the lower wing skin to the structural component, before, during or after
(d) positioning an upper wing skin in abutment with the second seating surface and securing the upper wing skin to the structural component,
wherein step (c) or step (d) includes inserting a bolt through an opening in that skin, through the aperture and into the nut, threadedly engaging the bolt with the nut and then tightening the bolt.

With the nut being mounted using the nut retention structure and the nut retention structure holding the nut in alignment with the aperture, it may be unnecessary for an operator to support the nut during tightening of a bolt. This, in turn, may reduce the number of design constraints which the design of the wing must fulfil, and/or may speed assembly by removing that relatively difficult step in the assembly process.

The nut retention structure permitting the nut lateral movement relative to the aperture axis may allow a joint to be made using pre-drilled holes without the need for adjustment. The nut may be able to move into alignment with the bolt inserted through the hole in the skin even if the hole is slightly misaligned with the aperture in the structural component.

For the avoidance of doubt, in steps (c) and (d), each skin may be positioned directly in abutment with the associated seating surface, or indirectly via one or more intermediate layers.

The method may further comprise moving the nut laterally relative to the aperture axis by inserting the bolt into the nut.

This may allow alignment of the nut with the bolt to be performed quickly and easily, in comparison to a method where the nut is moved by other means (such as using a nut alignment tool inserted into the nut through the hole in the skin before insertion of the bolt).

It will of course be appreciated that features described in relation to one aspect of the present invention may be incorporated into other aspects of the present invention. For example, the method of the invention may incorporate any of the features described with reference to the apparatus of the invention and vice versa. Further, it is to be noted that methods described herein are not intended to be limited to the steps of those methods being performed in the order in which they are recited. It would be readily apparent to the skilled person where steps can, or cannot, be performed in a different order.

### BRIEF DESCRIPTION OF THE DRAWINGS

Embodiments of the present invention will now be described by way of example only with reference to the accompanying schematic drawings of which:

FIG. 1 shows a perspective view of an aircraft according to a first embodiment of the invention;

FIG. 2 shows a simplified perspective cutaway view of a wing of the aircraft of FIG. 1;

FIG. 3 shows a cross-sectional view of a rib of the wing of FIG. 2

FIG. 4 shows a cross-sectional view of part of a sub-assembly comprising the rib of FIG. 3;

FIG. 5 shows a cross-sectional plan view of part of the sub-assembly of FIG. 4; and

FIG. 6 shows a cross-sectional side view of a joint in the wing of FIG. 2.

### DETAILED DESCRIPTION OF THE PREFERRED EMBODIMENTS

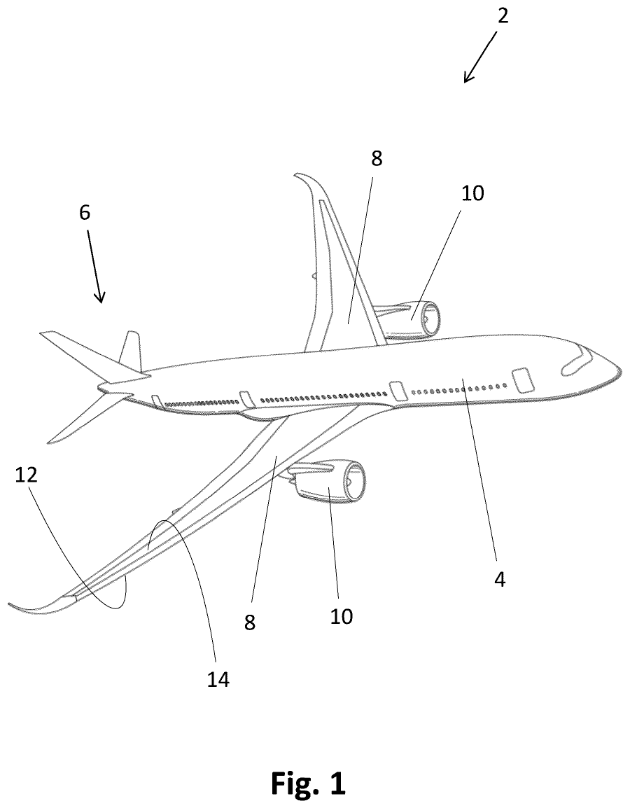

FIG. 1 shows an aircraft 2 according to an embodiment of the invention. It has a body 4, a tail 6 and two wings 8 each of which supports an engine 10. The outer surface of each wing 8 is made up of a lower skin 12 and an upper skin 14 which define an airfoil shape therebetween.

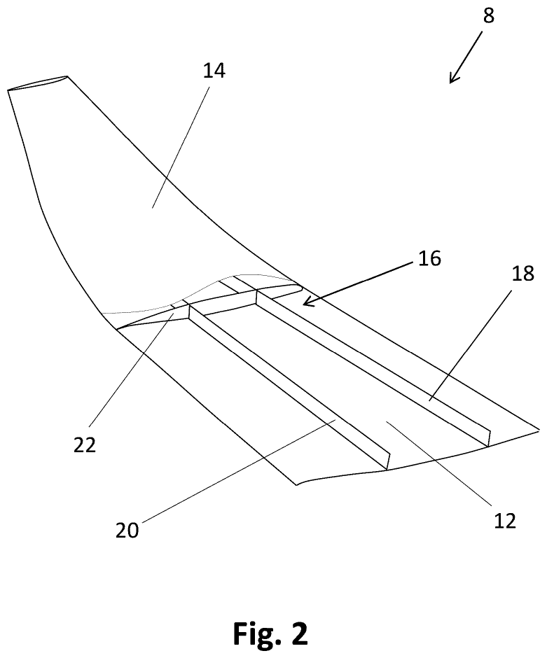

FIG. 2 shows the structure of the port wing 8 of the aircraft. The two wings 8 are mirror images of each other, therefore the features described in respect of the port wing 8 are equally applicable to the starboard wing 8 of the aircraft 2.

The lower skin 12 and upper skin 14 are supported by a wing frame 16 which is made up of a front spar 18, a rear spar 20 and a series of ribs 22 (one of which is shown in FIG. 2) distributed in the spanwise direction along the spars 18, 20. In this embodiment, each rib 22 is generally airfoil shaped, having a shape corresponding to the cross-sectional shape of the wing 8 at that point along the span. The ribs 22 differ from one another slightly in shape and size, but have the same general structure and function. The lower and upper skins 12, 14 are attached to the front and rear spars 18, 20 and to each rib 22 by a series of joints formed by bolts (not visible) as discussed in more detail later.

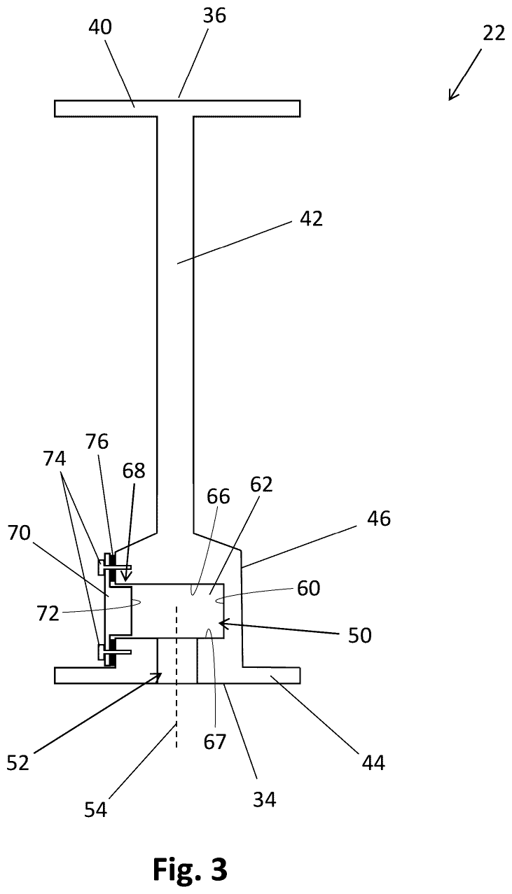

FIG. 3 shows the rib 22 in more detail. Referring now to FIG. 3 in combination with FIGS. 1 and 2, the rib 22 has a first seating surface 34 and a second seating surface 36. In the wing 8, the first seating surface 34 engages the lower skin 12 and the second seating surface 36 engages the upper skin 14. The portions of the seating surfaces 34, 36 visible in FIG. 3 face precisely away from one another, but other portions face generally away from one another, but not in exactly opposite directions. More particularly, the portions of the seating surfaces 34, 36 to the rear of the section shown in FIG. 3 face generally away from each other and slightly rearwards, and the portions' seating surfaces 34, 36 to the front of the section shown in FIG. 3 face generally away from each other and slightly forwards.

The second seating surface 36 of the rib 22 is provided on a simple flange 40 which extends a short distance spanwise in both directions from a central web 42 of the rib 22. The first seating surface 34 is also provided on a flange 44, but in this case the flange 44 is connected to the web 42 by an enlarged portion 46 in which a cavity 50 is defined. Also, the rib 22 has an aperture 52 which extends along an aperture axis 54, passes through the first seating surface 34 and intersects the cavity 50.

The cavity 50 of this embodiment is integral to the rib 22, rather than being a separate component attached thereto. The cavity 50 is generally cuboidal in shape. It has an end wall 60, two opposing side walls 62, 64, a roof 66 and a floor 67. It also has an entrance 68 through which the nut 28 can be inserted into the cavity, and a cover 70 which closes the entrance and provides another end wall 72. The cover 70 is attached to the enlarged portion 46 by screws 74, and has a sealing member 76 which seals the entrance 68 so as to prevent leakage of fluid (such as aviation fuel) into the cavity 50 therethrough.

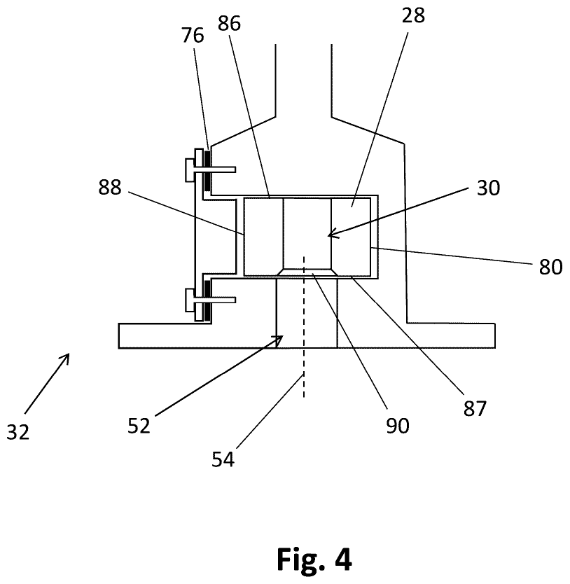

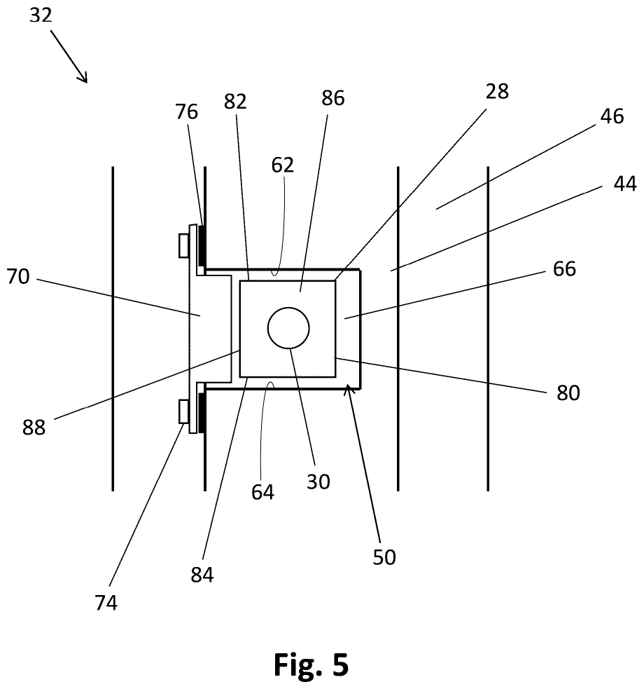

During assembly of the wing 8, a nut with a threaded hole is inserted into the cavity 50 to form a wing sub-assembly 32. The cavity 50 forms a nut retention structure which is configured to hold the nut in alignment with the aperture 52 but permit limited lateral movement of the nut 28 relative to the aperture axis 54. This will now be described with reference to FIGS. 1 to 3 in combination with FIG. 4, which shows the region of the wing sub-assembly 32 around the nut 28 and cavity 50 in cross section from the side, and FIG. 5, which shows this region in cross section from above.

The nut 28 with threaded hole 30 is substantially square in cross section. It has an end wall 80 facing towards the end wall 60 of the cavity, two side walls 82, 84 facing respective side walls 62, 64 of the cavity 50, a top 86 facing towards the roof 66 of the cavity 50, a bottom 87 facing towards the floor 67, and an end wall 88 facing towards the end wall 72 of the cavity 50 that is provided by the cover 70. The threaded hole 30 of the nut 28 has a flared mouth 90 which faces generally towards the aperture 52.

Together, the walls 60, 62, 64, 66, 67, 72 of the cavity 50 retain the nut 28, preventing it from leaving the cavity 50 and thus separating from the rib 22. Further, the side walls 62, 64 and end walls 60, 72 are configured to hold the nut in alignment with the aperture 52. Together, they prevent the nut 28 from moving to a position in which the aperture 52 does not intersect the nut 28. More particularly, they prevent the nut 28 from moving to a position where the aperture 52 does not intersect the threaded hole 30 of the nut 28.

That being said, the side walls 62, 64 and end walls 60, 72 of the cavity 50 are configured to permit the nut 28 limited lateral movement relative to the aperture axis 54. The side walls 62, 64 are spaced apart further than the side walls 82, 84 of the nut. The nut 28 can therefore move laterally between a position in which its side wall 82 abuts side wall 62 of the cavity 50 and a position in which its side wall 84 abuts side wall 64 of the cavity, through a range of positions in which side walls 62 and 82 and side walls 64 and 84 are spaced apart from one another to varying extents. Equally, the nut 28 can move laterally between a position in which its end wall 80 abuts end wall 60 of the cavity 50 and a position in which its end wall 88 abuts side wall 72 of the cavity, through a range of positions in which end walls 80 and 60 and end walls 88 and 72 are spaced apart from one another to varying extents. Accordingly, the walls 60, 62, 64, 72 co-operate to allow the nut 28 to move laterally in a plane which is perpendicular to the aperture axis 54.

While the distance between the roof 66 and floor 67 of the cavity 50 is larger than the distance between the top 86 and bottom 87 of the nut 28, so that the nut 28 can move laterally within the cavity 50 without undue friction, the roof 66 and floor 67 are positioned close enough together that there is minimal vertical clearance between the nut 28 and the cavity. More particularly, in this embodiment the nut 28 can move around 6 mm from one side of the cavity 50 to the other, and around 6 mm from one end of the cavity 50 to the other, but the nut 28 can only move vertically by around 0.5 mm. The nut 28 therefore has much less freedom of movement in a direction parallel to the aperture axis 54 (i.e., the vertical direction) than it has in any direction normal to the aperture axis (i.e., in any horizontal direction).

In this embodiment, each of the walls 60, 62, 64, 72 of the cavity 50 functions as an anti-rotation feature which limits rotation of the nut 28 about the aperture axis 54. If the nut is made to rotate, one of the corners formed by its walls 80, 82, 84, 88 contacts one of the walls 60, 62, 64, 72 of the cavity 50, stopping the nut from rotating any further. Exactly which corner(s) of the nut 28 would contact which wall(s) 60, 62, 64, 72 of the cavity 50 would depend on the exact position of the nut (and which direction in which the nut 28 was rotating).

It is noteworthy that in this embodiment the diameter of the aperture 52 is larger than the minor diameter of the threaded hole 30 of the nut. More particularly, in this embodiment the aperture 52 is 5 mm larger than the minor diameter of the nut. The significance of this will be discussed later.

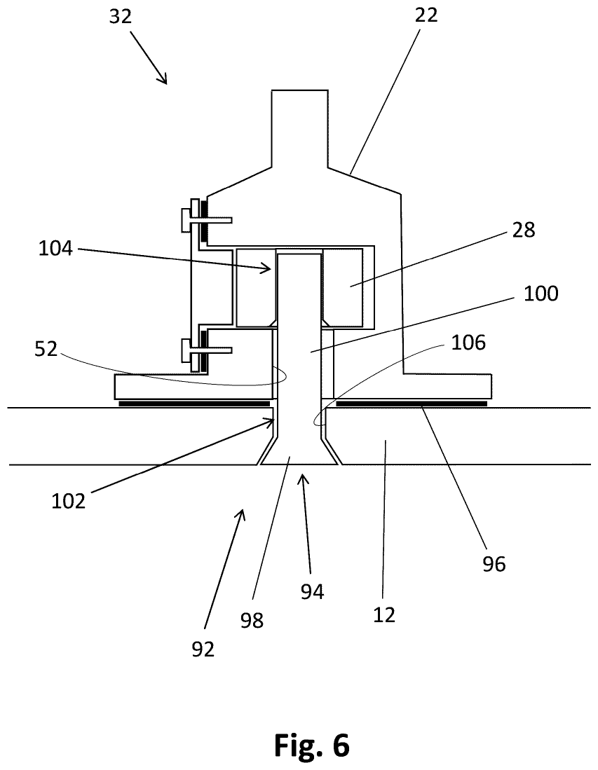

The nut 28 is used to form a joint by which the lower skin 12 is attached to the rib 22 in abutment with the first seating surface 34. FIG. 6, which will now be referred to in combination with FIGS. 1 to 5, shows this joint 92 in cross-section. In the present embodiment each rib 22 has a series of cavities 50 each retaining a corresponding nut 28, and each of those nuts 28 forms a separate joint 92. Each joint is generally the same in structure and function, therefore only one joint will be described in detail.

The joint 92 attaches the lower skin 12 to the rib 22 using a bolt 94, with the lower skin 12 abutting the first seating surface via an intermediate layer 96 in the form of a sealing gasket. The bolt 94 has a head 98 and a shank 100 which extends from a head end 102, through the hole 106 in the skin and through the aperture 52, to a distal end 104 which is threadedly engaged with the nut 28. The shank 100 extends through a hole 106 in the lower skin 12, through the aperture 52 and into the threaded hole 30 of the nut 28 in the cavity 50. The head 98 of the bolt is countersunk into the lower skin 12 to provide a generally flat surface.

In the case of a “wet wing”, the skins 12, 14 may act as walls of a fuel tank, with the rib 22 being located within the tank or forming another wall of the tank. The sealing gasket 96 is configured to prevent ingress of fuel between the first seating surface 34 and the lower skin 12, whereupon it may be able to leak out through the hole 106.

It is noteworthy that in the joint 92 of FIG. 6, the hole 106 in the lower skin 12 is slightly misaligned with the aperture 52 in the rib 22. From the perspective of FIG. 6 the hole 106 in the lower skin 12 is further to the left than the aperture 52. Due to the ability of the nut 28 to move laterally, and due to the size difference between the threaded hole 30 (and thus the bolt 94) and the aperture 52, this misalignment can be accommodated by positioning the nut 28 and bolt 94 similarly misaligned with the aperture 52 but aligned with the hole 106 in the skin 12.

A method of manufacturing the wing 8 of this embodiment will now be described with continued reference to FIGS. 1 to 6.

Firstly, the rib 22 is provided and the nut 28 is mounted to the rib 22 to form the wing sub-assembly 32. With the cover 70 unmounted so that the entrance 68 to the cavity 50 is open, the nut 28 is inserted into the cavity 50 with its flared mouth 90 facing towards the aperture 52. The cover 70 is then attached using the screws 74 so as to close the entrance 68 (and seal it in this case) and provide end wall 72.

The sub-assembly 32 is then joined to the front and rear spars 18, 20, along with other sub-assemblies made up of other ribs and nuts (not shown), in known fashion to form the frame 16. The upper skin 14 is then held in place, in abutment with the second seating surface via another intermediate layer (not shown), using jigs. The upper skin 14 is then joined to the ribs 22 and spars 18, 20 by match-drilling, inserting bolts (not shown) through the holes (not shown) and then tightening nuts (not shown) onto the bolts in known fashion.

The lower skin 12 is then held in position using jigs, with pre-drilled holes 106 each aligned (albeit perhaps imperfectly) with a corresponding aperture 52 in a rib 22 (or a bolt-hole in a spar). The distal end 104 of the shank 100 of each bolt 94 is inserted through the hole 106 in the lower skin 12, through the gasket 96, through the aperture 52 and into the threaded hole 30 of the nut 28. Due to the minimal clearance between the top 86 of the nut 28 and the roof 66 of the cavity 50, any upward force applied to the nut 28 by the bolt 94 does not lead to the bolt 28 lifting off the floor 67 of the cavity 50 to any appreciable extent.

As the distal end 104 of the shank enters the nut 28, it acts on the flared mouth 90 of the hole 30 and cams the nut 28 laterally so as to position the hole 30 in alignment with the shank 100. The bolt 94 is then rotated. One or more of the walls 60, 62, 64, 72 of the cavity acts as an anti-rotation feature and limits corresponding rotation of the nut 28, as discussed above. The nut 28 therefore tightens onto the bolt 94, clamping the first seating surface 34 and lower skin 12 against one another, with the gasket 96 compressed therebetween. The gasket 96 not only acts as a seal as discussed above, but also increases the friction between the first seating surface 34 and the lower skin 12 so as to reduce the risk of them slipping laterally relative to one another.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, while of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A wing sub-assembly for an aircraft wing, the wing sub-assembly comprising a structural component and an internally-threaded nut, wherein:
the structural component comprises a first seating surface positioned to engage a lower skin of the aircraft wing, and a second seating surface positioned to engage an upper skin of the aircraft wing;
the structural component has a bolt aperture which extends along an aperture axis and passes through one of said first and second seating surfaces; and
the structural component has a nut retention structure configured to hold the nut in alignment with the aperture but permit limited lateral movement of the nut relative to the aperture axis.

2. The wing sub-assembly according to claim 1 wherein the structural component is a rib or a spar.

3. The wing sub-assembly according to claim 1 wherein the nut retention structure is configured to permit lateral movement of the nut in a plane which is generally normal to the aperture axis.

4. The wing sub-assembly according to claim 1 wherein the nut retention structure comprises a cavity in which the nut is held.

5. The wing sub-assembly according to claim 4 wherein at least part of the cavity is integral to the structural component.

6. The wing sub-assembly according to claim 4 wherein the cavity has an entrance configured for insertion of the nut into the cavity therethrough, and a cover which closes the entrance.

7. The wing sub-assembly according to claim 6 wherein the cover has a sealing member which seals the entrance.

8. The wing sub-assembly according to claim 1 wherein the nut retention structure has an anti-rotation configuration which limits rotation of the nut about the aperture axis.

9. The wing sub-assembly according to claim 1 wherein the nut retention structure is configured to permit the nut less freedom of movement in a direction parallel to the aperture axis than in a direction normal to the aperture axis.

10. The wing sub-assembly according to claim 1 wherein the nut has a threaded hole with a minor diameter and the aperture has a minimum diameter, the minimum diameter of the aperture being larger than the minor diameter of the threaded hole of the nut.

11. The wing sub-assembly according to claim 1 wherein the nut has a flared mouth which faces towards the aperture.

12. An aircraft wing component comprising a skin support and fastener with a female thread, wherein:
the skin support has a first surface for supporting a first wing skin and a second surface for supporting a second wing skin, the first and second surfaces facing in generally opposite directions;
the skin support has a hole which passes through the first surface or the second surface; and
the fastener is mounted to the skin support using mounting configurations which retain the fastener while allowing the fastener to move sideways relative to the hole.

13. An aircraft wing comprising:
a sub-assembly according to claim 1;
a lower skin engaged by the first seating surface;
an upper skin engaged by the second seating surface; and
a bolt having a shank which extends from a head end, through an opening in one of said upper and lower skins and through said aperture, to a distal end which is threadedly engaged with the nut.

14. The aircraft wing according to claim 13 further comprising an intermediate layer positioned between a seating surface through which the aperture passes, and a corresponding skin.

15. The aircraft wing according to claim 14 wherein the intermediate layer is a sealing gasket.

16. An aircraft comprising an aircraft wing sub-assembly according to claim 1.

17. An aircraft comprising an aircraft wing component according to claim 12.

18. An aircraft comprising an aircraft wing according to claim 13.

19. A method of manufacturing an aircraft wing, the method comprising:
(a) providing a structural component which comprises a first seating surface, a second seating surface, and a bolt aperture which extends along an aperture axis and passes through one of said first and second seating surfaces;
(b) mounting an internally-threaded nut to the structural component using a nut retention structure, the nut retention structure holding the nut in alignment with the aperture but permitting limited lateral movement of the nut relative to the aperture axis; and
(c) positioning a lower wing skin in abutment with the first seating surface and securing the lower wing skin to the structural component, before, during or after
(d) positioning an upper wing skin in abutment with the second seating surface and securing the upper wing skin to the structural component,
wherein step (c) or step (d) includes inserting a bolt through an opening in that skin, through said aperture and into the nut, threadedly engaging the bolt with the nut and then tightening the bolt.

20. The method according to claim 19 further comprising moving the nut laterally relative to the aperture axis by inserting the bolt into the nut.
